(19) United States
(12) Patent Application Publication
(10) Pub. No.: US 2005/0120235 A1
(43) Pub. Date: Jun. 2, 2005

(54) Methods and devices for controlling the access to a data processing device

(76) Inventors: Heiko Zimmermann, Saarbruecken (DE); Guenter R. Fuhr, Berlin (DE); Rolf Hagedorn, Berlin (DE)

Correspondence Address: BUCHANAN INGERSOLL PC, 1835 MARKET STREET, 14TH FLOOR, PHILADELPHIA, PA, 19103-2985, US

(21) Appl. No.: 10/502,164

(22) PCT Filed: Jan. 22, 2003
(86) PCT No.: PCT/EP03/00614

(30) Foreign Application Priority Data
Jan. 22, 2002 (DE) 102 02 302.6

(51) Int. Cl. G11C 5/00; G06F 11/30; G06F 12/14; H04L 9/32; H04L 9/00

(52) U.S. Cl. 713/200; 365/244

(57) ABSTRACT

A method and devices for controlling access to a data processing device, in particular a data memory, having an access filter circuit (10) are described, whereby the access filter circuit (10) is operated with enabled access in a read-write mode at a normal operating temperature and with limited access at an access protection temperature which is lower than the normal operating temperature.

This invention relates to methods of controlling access to a data processing device having an access filter circuit, in particular to methods of controlling access to electronic data memories, such as methods of physical protection of access to data memories, and to devices for implementing such methods.

With the growing use of electronic data processing in the industry, science and administration as well as in the household area, there is also a growing demand for reliable protection of data processing equipment and in particular data memories. This protection should be directed first at preventing unauthorized access to stored data. On the other hand, access protection should also prevent unintentional altering of stored data. The same thing is also true for protection of data processing devices or control systems for technical installations.

Access protection may be based on a program (software protection). For example, data access is linked to password protection or a protection program (so-called firewall). As an alternative, physical protection is also possible, for example, by separating the transmission channel over which access to a data memory would take place. Any access to the computer thus separated is reliably prevented by isolating a computer from a data network.

The traditional techniques for access protection for data processing devices and in particular data memories are well developed and widespread. However, they also have a number of disadvantages which are manifested in particular in their reduced safety or complicated handling. Thus, establishing software protection is always associated with risks. With the current technique, an access by unauthorized users into computer networks can only be made more difficult but cannot be reliably ruled out entirely. Physical protection, however, requires measures for reliable separation and connection of a computer in a network.

There are applications for data processing devices in the technology where especially high requirements are made of the safety of access control but such requirements can be achieved only through physical protection. However, the respective data processing device may be inaccessible for traditional physical access protection because of the operating conditions. For example, this is true of the use of electronic controls or data memories in operating methods or other procedures which are carried out under extreme ambient conditions.

U.S. Pat. No. 6,009,033 describes a method for increasing the optional reliability of an EEPROM memory. To prevent data errors, it is proposed that programming processes and deletion processes should be carried out at an elevated operating temperature of the memory in order to avoid unwanted charging phenomena in the memory and thus increase the long-term reliability of the memory. Physical access protection to meet the requirements specified above cannot be achieved with this technique.

The object of this invention is to make available improved methods for controlling access to data processing devices, in particular electronic data memories, with which the disadvantages of conventional methods are overcome and which permit in particular a high access reliability with good handling. The object of this invention is also to provide devices for implementing such methods.

These objects are achieved by methods and devices having the features according to patent claims 1 and 10. Advantageous embodiments of this invention are defined in the dependent claims.

The basic idea of this invention is to provide physical access control for data processing devices, in particular electronic data memories in which free or limited access to the data processing device with or via an access filter circuit is provided as a function of the operating temperature. At a normal operating temperature, e.g., at room temperature, full access to the data processing device via the access filter circuit is ensured. The device is in a read/write mode. At a reduced access protection temperature, access to the data processing device is possible only to a limited extent. The inventors have found for the first time that by reducing the operating temperature of an access filter circuit, e.g., a data memory or part of a memory, first the function of the access filter circuit and in particular the access rate are completely preserved until at least write access is prevented below a limit temperature. A reproducible physical access control is advantageously achieved with only one operating parameter, namely temperature. In contrast with the conventional physical access protection, this method can be handled easily and can be automated.

According to a first preferred embodiment of the invention, the access filter circuit is operated at a write protection temperature at which the access filter circuit is in a read-only mode. Data in the data processing device can be read, but deletion of data or input of data is prevented in this mode. According to another preferred embodiment, the access filter circuit is operated at a read/write protection temperature at which it is in a completely blocked state. Both reading and writing of data are prevented. The physical protection is thus adjustable for various functions of the access filter circuit or the data processing device connected to it or other technical facilities, depending on the concrete embodiment.

The reduction in operating temperature is advantageously accomplished with a coolant such as liquid nitrogen or the vapor of liquid nitrogen or with an electric refrigeration device such as a Peltier element. The first case offers special advantages with regard to the security of access control. As long as the access filter circuit is in contact with the coolant, unwanted data access can be prevented. Additional advantages are achieved when the inventive method is used in conjunction with a technical process in which the coolant also assumes other functions, e.g., in cryopreservation or cryostorage. Cooling with a Peltier element has the advantage that it further simplifies handling of the process.

According to another advantageous embodiment of the inventive process, a data memory is itself used as an access filter or an access filter circuit for another technical device such as a data processing device or another memory. Although physical access protection is implemented only on the data memory itself which forms the access filter, larger technical installations can be protected from unauthorized access.

Another subject of the invention is a device for controlling access to a data processing device which is set up in particular for implementation of the inventive method. The safety device contains at least one access filter circuit and in particular a cooling device which includes a coolant bath or a Peltier element, for example.

The invention has the following additional advantages. For improved access control, cryotechniques which are essentially available already may be used. The access control can be implemented in existing systems with little effort. The invention can be used in general for function control of semiconductor components. For access protection of a data memory, it is not absolutely necessary to cool the entire data memory. Depending on the design, it is sufficient according to this invention to adjust the access protection temperature on a part of the data memory, e.g., on a controller circuit or the like.

The invention provides a reliable, independent and autonomously implementable access control without mechanical elements for a bulk memory. Physical access protection without moving mechanical components has the fundamental advantage that the lifetime of components is not shortened due to wear or corrosion. The access protection provided during operation below the write/read temperature in particular is as reliable as access protection based on physical separation. In the field of cryopreservation, in particular of biological specimens, where the specimens are stored with a data memory, access protection is obtained automatically when the specimen is frozen.

Additional advantages and details of this invention are described below with reference to the accompanying drawings, which show:

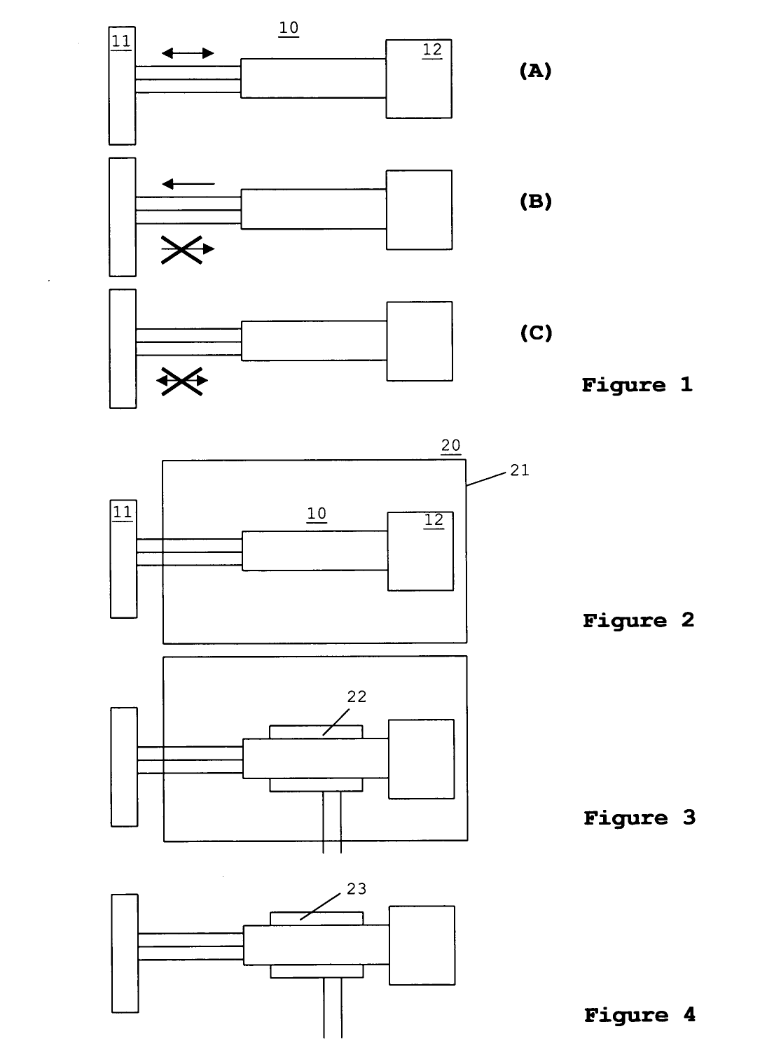

FIG. 1 schematic illustrations of the inventive process, and

FIGS. 2-4 schematic illustrations of various embodiments of inventive devices.

The inventive access control is based on the following principles. Electronic semiconductor components are usually tested and certified for normal operation within a certain temperature range. The temperature range usually includes an interval from an upper limiting temperature above room temperature to a lower limiting temperature of approximately −40° C. to −60° C. If the component is operated at a temperature (normal operating temperature) within this temperature range, its function is fully guaranteed. For example, data memories can be written to and read, i.e., they are in the read-write mode. If a temperature below the certified temperature range of normal operation is set (access protection temperature), the function of the component is at least partially hindered or blocked. One particular advantage of the invention is that this loss of function below the lower limit temperature is not based on the conduction processes in the component itself but instead on its ability to store data. In addition, this loss of function is reversible. If the component, in particular the data memory, is again heated to a normal operating temperature, the write-read ability is restored and the stored data is available. This switching between free access and limited access can be repeated as often as desired to advantage.

For access control, it is possible to switch between the write-read mode and a read-only mode or a complete access block. For example, if a write protection temperature at which the memory is in read-only mode is selected as the access protection temperature, then data can be read but cannot be written. By further cooling down to a write-read protection temperature, reading of the data is also suppressed.

The invention will now be explained below with reference to a preferred embodiment as an example, where the access filter circuit is formed by a data memory or a part thereof, for example, a temporary memory such as a cache memory (e.g., RAM). However, the implementation of the invention is not limited to this example, but instead it can be also be implemented with other types of data processing devices having an integrated or additional access filter circuit.

In FIG. 1, the various states of access to a data memory 10 are illustrated schematically. The data memory 10 is connected via a bus connection first to an interface 11 and second to a downstream data processing device or some other technical device 12. The data memory 10 may be, for example, an EEPROM or a flash memory, each optionally with additional devices such as controller circuits or the like. At the normal operating temperature according to FIG. 1A, complete access to the data memory 10 is ensured (see double arrow). At a write protect temperature of the data memory (10) or a part thereof (e.g., a controller circuit) according to FIG. 1B, only the reading of data is possible but writing or deletion of data is impossible. The readout of data may be performed to advantage with almost no change in access time and with no errors.

Finally, at a write-read protection temperature according to FIG. 1C, neither reading of nor writing to the data memory 10 is possible. There is complete physical access protection.

The normal operating temperature, the write protection temperature and the write-read protection temperature are each set according to the technical parameters of the data memory 10. The normal operating temperature is above −60° C., for example. The write protection temperature is in the range of −60° C. to −120° C., for example, preferably in the range of −70° C. to −100° C. Complete access protection is obtained at temperatures below −120° C., for example.

Instead of data memory 10, another semiconductor component, e.g., a circuit specifically developed for this purpose, may be provided according to this invention; this circuit loses or changes a part of its function at a temperature below the respective limit temperature. The data memory 10 or the corresponding semiconductor component may form an access filter for access to the downstream device 12, which is optionally operated at room temperature.

FIGS. 2 through 4 illustrate various embodiments of inventive devices designed for controlling access to the electronic data memories. Inventive devices are characterized in particular by a cooling system 20, which is formed by a coolant container 21 according to FIGS. 2 and 3. At least the data memory 10 or a part thereof is situated in the coolant container 21. Depending on the application, the downstream device 12 is also situated in the coolant container 21. The coolant container 21 contains a liquid coolant (e.g., liquid nitrogen). The data memory 10 is situated at least partially in contact with the coolant or in a vapor of the coolant. Adjusting the temperature with liquid coolant is a method that is essentially known from cryotechnology, so that no further details need be explained here regarding the temperature adjustment on the data memory 10.

According to a modified embodiment, as shown in FIG. 3, a heating device 22 may also be provided on the data memory 10 with which the data memory 10 can be converted locally from a reduced temperature to the normal operating temperature. This is particularly advantageous when a plurality of data memories is situated in the coolant container 21, as occurs in cryostorage of biological specimens, for example. The heating device 22 is a resistance heater which can be operated from the outside in order to partially or completely enable access to certain data memories without influencing the other data memories.

The cooling device of the device according to this invention may also be formed by a Peltier element 23 according to FIG. 4. The Peltier element is situated in close thermal contact with the data memory 10. Access control is achieved by adjusting the desired temperature with the Peltier element. A combination of a Peltier element and a heating device may also be provided.

Another application of the invention is in the following embodiment of an automated cryobank with at least one cryocontainer. The cryocontainer contains a plurality of biological specimens, each in combination with a data memory. When the specimen data memory combinations or multiple cryocontainers are connected like a network to a central control, the invention supplies a firewall with which unwanted access to individual data memories or to the entire cryocontainer can be suppressed. The cryocontainer has nitrogen, for example, at the bottom, with the specimens arranged in the nitrogen vapor above the bottom. A thermal gradient is formed above the bottom, with the temperature increasing with an increase in height above the bottom. According to the invention a circuit which acts as an access filter or a specimen data memory combination may be moved to a higher level by a mechanical device (e.g., a cable pull) in the cryocontainer, so that the temperature at the respective height permits reading or reading and writing of data. The mechanical device serves to increase the temperature as needed. The cryocontainer here is itself used as a cooling system to control access to the data processing device (specimen data memory).

The features of this invention disclosed in the preceding description, the drawings and the claims may be relevant for implementation of this invention in its various embodiments either individually or in combination.

1. A method for controlling access to a data processing device having an access filter circuit, comprising the steps of:
operating the access filter circuit with enabled access at a normal operating temperature in a read-write mode and with limited access at an access protection temperature which is lower than the normal operating temperature, wherein
the access protection temperature is adjusted by reducing an operating temperature of the access filter circuit.

2. The method according to claim 1, wherein a write protection temperature is selected as the access protection temperature at which the access filter circuit is operated in a read-only mode.

3. The method according to claim 1, wherein a write-read protection temperature is selected as the access protection temperature at which access to the access filter circuit is completely suppressed.

4. The method according to claim 1, wherein the access protection temperature is adjusted with a coolant.

5. The method according to claim 1, wherein the access protection temperature is adjusted with a Peltier element.

6. The method according to claim 1, wherein the temperature of the access filter circuit is raised by a heating device for the transition to the read-write mode.

7. The method according to claim 1, wherein a data memory or part of a data memory is used as the access filter circuit.

8. The method according to claim 1, wherein the access filter circuit forms all or part of the data processing device.

9. The method according to claim 7, wherein the access protection temperature is adjusted with a coolant system on a part of the data memory.

10. A device for controlling access to a data processing device including:
an access filter circuit being capable to be operated with free access at a normal operating temperature in a read-write mode and to be operated with limited access at an access protection temperature which is lower than the normal operating temperature, and
a cooling system being provided for adjusting the access protection temperature.

11. The device according to claim 10, wherein the cooling system includes at least one of a cooling container and a Peltier element.

12. The device according to claim 10, wherein a heating device is provided on the access filter circuit.

13. The device according to claim 10, wherein the access filter circuit comprises a data memory or part of a data memory.

14. The device according to claim 10, wherein the data processing device comprises a data memory, where the access filter circuit is formed by the data memory or a part of a data memory.

15. (canceled)

16. The device according to claim 10, wherein the cooling system is provided for a cryopreservation of biological specimens.

17. The method according to claim 4, wherein liquid nitrogen or the vapor of liquid nitrogen is used as the coolant.
